(19) United States
(12) Patent Application Publication
(10) Pub. No.: US 2009/0107639 A1
(43) Pub. Date: Apr. 30, 2009

(54) Tire Mounting Tool for Aluminum Wheels

(76) Inventor: Davd D. Foster, Maple Grove, MN (US)

Correspondence Address: BILL L. COUNTRYMAN, 4026 E. ALDER AVENUE, MESA, AZ, 85206, US

(21) Appl. No.: 11/925,024

(22) Filed: Oct. 26, 2007

(51) Int. Cl. B60C 25/02

(52) U.S. Cl. 157/1.3

(57) ABSTRACT

The aluminum wheel tire mount tool is designed to protect aluminum wheels from scratches on smaller vehicles such as ATVs, Golf Carts, Scooters and Motorcycles while at the same time allowing easier installation by the installer. This tool is manufactured from a plastic with a very high tensile strength that will prevent scratches. The hook or thumb-like projection on the tool pushes the bead of the tire down onto the wheel without taking up space which allows for an easier installation.

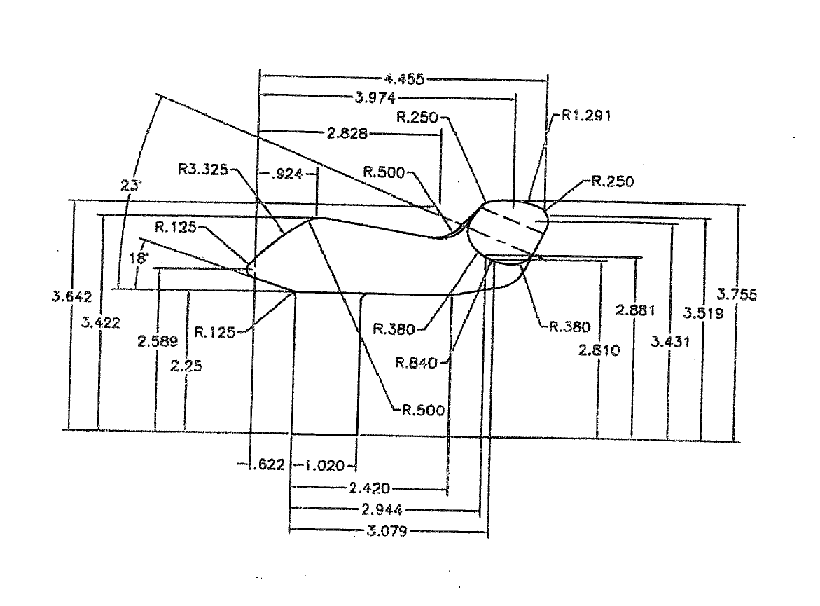

The aluminum wheel tire mount tool enables the installer to mount tires on aluminum wheels For ATV, Golf Carts, Scooter and Motorcycle wheels using a manual tire changer with a center post without scratching the wheel.

It is made of a glass-filled plastic, strong and will not scratch the wheel

The design of the tool allows mounting of the tire without taking up space between the tire bead and the wheel. This enables an installer to mount tires on wheels with a shallow drop center on the wheel.

The installer mounts the wheel in a tire machine with the center post in position. Lubricate the beads of the tire and edge of the wheel with a good tire mounting lubricant. Set the tire on the wheel. Hook the tool on the edge of the wheel with the shaft of the tool on the opposite side of the center post from the installer. Align the leading edge of the tool to the inside edge of the bead of the tire. Push the bead of the tire under the trailing edge of the tool. Pull on the opposite end of the shaft with your right hand. Pull around the center post until the first bead drops onto the wheel. Repeat the second bead. Be sure the bead is dropping into the drop center of the wheel during installation of each bead.

A brief description of the view of the attached drawing is as follows: The drawing of the Tire Mount Tool is from the side. The mount tool gets affixed to a tubular shaft for leverage purposes. The view shows the curvature of the mount tool head that slides between the bead of the tire and the tire itself thereby preventing the aluminum rim from being scratched.

### BACKGROUND OF INVENTION

When mounting tires on aluminum ATV, Golf Carts, Scooter and Motorcycle wheels with existing manual tire tools there are two problems. First, the wheel gets scratched due to the metal tire tools. Secondly, most aluminum wheels have a very shallow drop center. This makes it difficult to impossible to install the tire using other manual tire tools as they require space to be between the tire bead and the wheel.

This tool is made of plastic enabling the installer to mount a tire without scratching the wheel. The design of this tool makes it possible to install the tire without taking up space between the tire bead and wheel. This makes is possible to mount tires on wheels which have a shallow drop center.

### DETAILED DESCRIPTION OF THE INVENTION

The aluminum tire mounting tool is made of a plastic compound with a very high tensile strength. Therefore it does not scratch aluminum wheels. It can be either machined or molded.

The design of the tool enables an installer to mount a tire using a manual center post tire machine.

Old and existing style tools fit between the tire bead and the wheel. This results in a more difficult installation. This tool aligns the tire bead to the outside of the wheel. The thumb or hook on the tool rides on top of the bead pushing it below the edge of the wheel.

The installer mounts the wheel in a tire machine with the center post in position. Lubricate the beads of the tire and edge of the wheel with a good tire mounting lubricant. Set the tire on the wheel. Hook the tool on the edge of the wheel with the shaft of the tool on the opposite side of the center post from the installer. Align the leading edge of the tool to the inside edge of the bead of the tire. Push the bead of the tire under the trailing edge of the tool. Pull on the opposite end of the shaft with your right hand. Pull around the center post until the first bead drops onto the wheel. Repeat for the second bead. Be sure the bead is dropping into the drop center of the wheel during installation of each bead.

### BRIEF SUMMARY OF THE INVENTION

The aluminum wheel tire mount tool enables a tire installer to mount ATV, Golf Cart, Scooter and Motorcycle tires on aluminum wheels using a manual tire changer without damaging the wheels or tires.

1. The tool is made of a plastic compound with a very high tensile strength which will not scratch the aluminum wheel.

2. Because no space is required between the tire bead and the edge of the wheel the aluminum wheel tire mount tool facilitates easier installation of tires.
